(19) United States
(12) Patent Application Publication
(10) Pub. No.: US 2013/0111105 A1
(43) Pub. Date: May 2, 2013

(54) NON-VOLATILE DATA STRUCTURE MANAGER AND METHODS OF MANAGING NON-VOLATILE DATA STRUCTURES

(71) Applicants: Antonio Lain, Menlo Park, CA (US); Nathan Lorenzo Binkert, Redwood City, CA (US)

(72) Inventors: Antonio Lain, Menlo Park, CA (US); Nathan Lorenzo Binkert, Redwood City, CA (US)

(21) Appl. No.: 13/285,675

(22) Filed: Oct. 31, 2011

(51) Int. Cl. G06F 12/02

(52) U.S. Cl. 711/103; 711/E12.008

(57) ABSTRACT

Non-volatile data structure managers and methods to manage non-volatile data structures are disclosed. An example non-volatile data structure manager includes a persistent data structure (PDS) to maintain at least one version of a non-volatile heap; a PDS versioner to create a version of the PDS reflective of a state of the non-volatile heap; and a memory updater to perform a direct memory update of the non-volatile heap in response to a write call routed from an application that shares a region of memory corresponding to the non-volatile heap as read-only, wherein the creation of the version of the PDS is caused by the direct memory update.

### BACKGROUND

Computing platforms often employ multiple types of memory to address different needs. Each type of memory has advantages and disadvantages relative to other types of memory with respect to, for example, cost, latency, bandwidth, and/or durability. For example, non-volatile memory is durable and, thus, is used to store data that needs to be preserved in the absence of power to the memory. On the other hand, volatile memory has low latency compared to non-volatile memory and, thus, is used to store data that needs to be quickly accessed or read. Non-volatile random access memory (NVRAM) is a type of memory having latency and bandwidth advantages of conventional random access memory (RAM) (e.g., dynamic RAM (DRAM)) and durability advantages of disk storage.

### BRIEF DESCRIPTION OF THE DRAWINGS

FIG. 1 illustrates a processing platform capable of implementing an example non-volatile (NV) data structure manager disclosed herein.

FIG. 2 is a block diagram of an example implementation of the NV data structure manager of FIG. 1.

FIG. 3 is a flowchart representative of example machine readable instructions that may be executed to initialize the example NV heap manager of FIG. 2.

FIG. 4 is a flowchart representative of example machine readable instructions that may be executed to operate the example NV heap manager of FIG. 2.

FIG. 5 is a flowchart representative of example machine readable instructions that may be executed to restore an example NV heap using the example NV heap manager of FIG. 2.

FIG. 6 is a block diagram of an example processor system capable of executing the example machine readable instructions of FIGS. 3-5 to implement the example NV data structure manager of FIGS. 1 and/or 2.

### DETAILED DESCRIPTION

Because non-volatile memory stores data that is expected to be preserved, memory managers typically employ robust protection mechanisms or safeguards for non-volatile memory. However, some of the protection mechanisms or safeguards decrease one or more performance factors associated with the corresponding memory. For example, updates to non-volatile memory are typically managed by an operating system and a file system implemented by the operating system. The operating system mediates (e.g., via a kernel) interactions between software (e.g., a program or an application) and memory. The mediation provided by the operating system reduces exposure of the memory to possible corruption caused by, for example, crashes of the software. However, the involvement of the operating system introduces significant overhead that negatively impacts performance of memory operations, such as writes and/or reads. Further, block-level interfaces typically used by file systems to facilitate memory operations and to organize data storage are inflexible (e.g., by using only fixed chunks of data) and also negatively impact performance of memory operations.

For some types of memory, the protection provided by the operating system mediation is worth the reduction in performance caused by the overhead of the operating system. However, for other types of memory, the drawbacks introduced by the operating system protections diminish the advantageous aspects of those memories, sometimes to an unacceptable degree. For example, a major advantage of non-volatile random access memory (NVRAM) is the decreased latency compared to other non-volatile memories. The latency benefit of NVRAM may be undermined by the operating system overhead to a degree that makes the NVRAM an undesirable option for a particular situation.

This performance tradeoff has led to memory managers that circumvent certain operating system protections for some types of memory. For example, some memory managers perform direct memory operations to avoid the negative impacts on performance caused by operating system management of memory. As referred to herein, a direct memory operation (e.g., a direct memory read or a direct memory write/update) is one performed without mediation by a protection mechanism of an operating system. For example, a direct memory write in NVRAM initiated by an application may be facilitated by a memory manager associated with the NVRAM without the use of an operating system. By avoiding the operating system, the direct memory operation is not subjected to the block-level interface implemented by the file system that manages memory updates and/or organization. Additionally, by avoiding the operating system, the direct memory operation is not subjected to the increased latency of context switches between an application and the operating system.

To enable applications to facilitate direct memory operations, data structures associated with the NVRAM, such as a non-volatile heap (NV heap), share an address space with the applications. Sharing an address space with applications creates a safety issue for NVRAM, especially because the NVRAM is durable (e.g., survives application crashes). In particular, when NVRAM is shared with an application utilizing the NVRAM, if the application crashes due to a bug or a malicious exploit, arbitrary memory addresses can be written with random content, potentially corrupting data structures of the NVRAM, such as the NV heap.

Previous attempts to alleviate or fix the safety issue of applications sharing an address space with NV data structures have fallen short. For example, some systems rely on Software Transactional Memory (STM) mechanisms that track pending writes that are atomically written when a transaction commits. However, the STM mechanisms can be bypassed by an attacker when, for example, a buffer or stack overflows, thereby allowing arbitrary changes to the NV data structures. Other attempts include similar problems with exposing the NV data structures to applications and the potential bugs of the applications that corrupt the NV data structures.

Example NV data structure managers and methods of managing NV data structures are disclosed herein. Example managers disclosed herein provide a safe environment in which direct memory operations initialized by an application can be performed on a NV data structure that shares an address space with the application. As described in greater detail below, example managers disclosed herein share the NV data structure with the application as read-only. In previous systems, an application performing direct memory operations (e.g., without operating system mediation) was provided read/write access to the NV data structure to facilitate store instructions. In contrast, applications interacting with the NV data structure managed by the example managers disclosed herein are limited to read-only access with the NV data structure.

To enable direct memory writes, example managers disclosed herein provide a trusted module separate from the application. The example trusted module disclosed herein includes a memory updater (e.g., a tightly controlled updater) that is designed to eliminate vulnerabilities associated with memory writes. Compared to an application that has a high degree of complexity (e.g., complicated program logic of the thousands of lines of code used to program the application), the example trusted module disclosed herein has a significantly lower amount of instructions (e.g., under fifty lines of code) dedicated purely to updating a particular NV data structure, such as an NV heap. Thus, the trusted module is far less likely (if at all) to corrupt the NV data structure.

The example managers disclosed herein employ persistent data structures (PDSs) to ensure that the NV data structure can be recovered in the event of, for example, a software crash. Example managers disclosed herein span the PDS across a NV data structure (e.g., a NV heap) such that the content of the PDS corresponds to the content of the NV data structure, thus providing rollback options for the NV data structure. The PDS is a data structure that preserves a previous version of itself each time the PDS is modified. The PDS stores the previous version along with other previous versions of the PDS. Thus, the PDS is a log of versions of itself. Instead of updating in-place in response to an update request, the PDS creates a new version of itself corresponding to a state of the NV data structure before the update request. Because example managers disclosed herein span the PDS across NV data structures, at least one previous version of the NV data structure is preserved. Example managers can roll the NV data structure back to this previous version of the NV data structure in the event of, for example, a trigger such as a software crash, data being corrupted by malicious code, and/or data being corrupted by a software crash.

Thus, as described in greater detail below, example managers disclosed herein reduce the likelihood of memory corruption from an application by providing a trusted module dedicated to performing updates of the memory instead of the application. Further, example managers described herein preserve an ability of the memory to rollback to a previous version of the memory corresponding to, for example, a state of the memory prior to an application crash or data corruption.

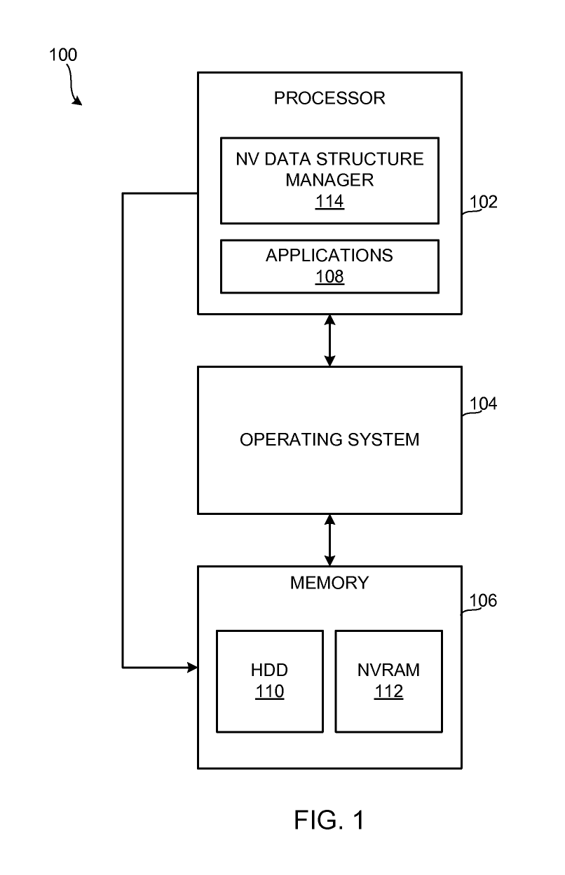

FIG. 1 is an example computing platform 100 implemented in accordance with the teachings of this disclosure. In particular, the computing platform 100 is one in which example NV data structure managers and/or methods to manage NV data structures disclosed herein may be implemented. The example computing platform of FIG. 1 includes a processor 102, an operating system 104, and memory 106. The processor 102 executes instructions of one or more programs and/or applications 108. The operating system 104 provides the processor 102 with access to hardware components of the computing platform 100 such as, for example, input/output devices and/or the memory 106, and facilitates interactions between the processor 102 and the hardware component(s). For example, the operating system 104 includes a kernel to manage privilege levels of the platform 100, to determine an order in which instructions or processes are executed, to manage memory access, etc. For some type(s) of memory 106 of FIG. 1, the operating system 104 (e.g., via the kernel) manages memory access, allocation, organization, etc.

As described above, the memory management performed by the operating system 104 offers protection from, for example, data corruption in the memory 106. In the illustrated example, the memory 106 includes a hard disk drive (HDD) 110 that relies on the memory protection mechanisms of the operating system 102. Data stored in the HDD 110 is data that must be preserved but to which fast access may not be available or necessary. Therefore, the memory protection mechanisms provided to the HDD 110 by the operating system 104 is appropriate. On the other hand, NVRAM 112 of the memory 106 is a desirable non-volatile storage option for data that provides faster access than data stored in the HDD 110. That is, the NVRAM 112 provides a non-volatile storage option having lower latency than the HDD 110. Accordingly, the negative impact on latency of the operating system protection mechanism(s) is less tolerable for the NVRAM 112 than the HDD 110. While the example NVRAM 112 of FIG. 1 is part of the memory 106, in other examples, the NVRAM is implemented in connection with other components such as, for example, in peripheral memory device(s) coupled to the computing platform 100 and/or on a networked device in communication with the computing platform 100.

To enable direct memory operations for one or more data structures associated with the NVRAM 112 and to provide protection from, for example, data corruption resulting from a crash of one or more of the applications 108, the example platform 100 of FIG. 1 includes at least one NV data structure manager 114. In the illustrated example of FIG. 1, the NV data structure manager 114 is implemented in the processor 102. However, the NV data structure manager 114 can be at least partially implemented in additional or alternative components of the platform 100 and/or another computing platform. For example, certain aspects of the NV data structure manager 114 may be implemented in the memory 106 and/or the NVRAM 112.

The NV data structure manager 114 of the illustrated example enables one or more of the applications 118 to interact directly with data structures of the NVRAM 112, such as an NV heap. As used herein, the phrase “interact directly with the data structures of the NVRAM” means to perform memory operation(s) on the NVRAM 112 without mediation from the operating system 104 and/or a file system implemented by the operating system 104. While circumventing the operating system 104 also circumvents the memory protection provided by the operating system 104, the example NV data structure manager 114 of FIG. 1 protects the data structures of the NVRAM 114 from crashes of the applications 108 and from loss of data written to the NVRAM 114 before crashes of the applications 108. That is, the NV data structure manager 114 of the illustrated example reduces (e.g., eliminates), the likelihood that a crashing application (or a non-crashing application) will corrupt data of the NVRAM 112 and enables a rollback of the NVRAM data structures to a state known to be uncorrupted (e.g., a state of an NV heap prior to an application crash).

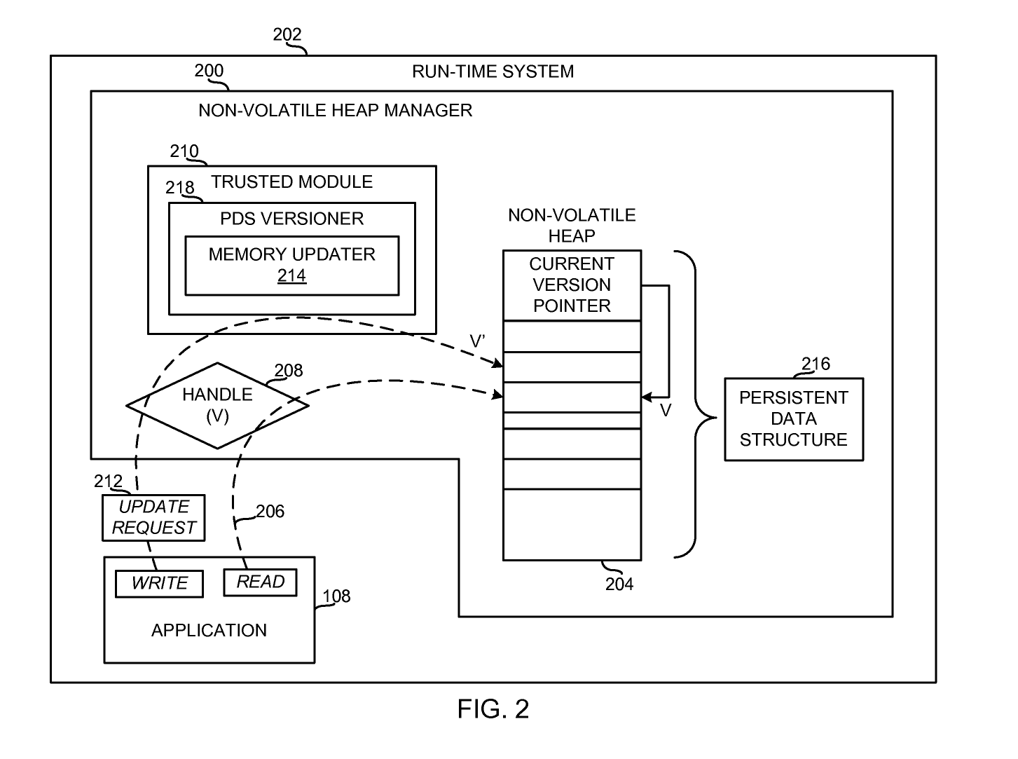

FIG. 2 illustrates an example manner of implementing the example NV data structure manager 114 of FIG. 1. In the illustrated example of FIG. 2, the NV data structure to which the example implementation of the example NV data structure manager 114 is assigned is an NV heap of the NVRAM 112 of FIG. 1. Thus, the example NV data structure manager 114 of FIG. 2 is sometimes referred to herein as a NV heap manager 114. Other implementations of the NV data structure manager 114 are assigned to and/or customized for different types of data structures and/or different types of memories.

In the illustrated example of FIG. 2, the NV heap manager 114 operates in a run-time system 202 facilitated by the processor 102 of FIG. 1. In the example of FIG. 2, one of the applications 108 is configured to interact with a NV heap 204 associated with the NVRAM 112. The NV heap 204 of the illustrated example is a data structure that facilitates usage of the NVRAM 112. The run-time system 202 of the illustrated example views the NV heap 204 as an opaque blob. Because the application 108 is configured to interact with a data structure of the NVRAM 112, the run-time system 202 of the illustrated example causes the application 108 to use the NV heap manager 114 to facilitate direct memory operations without mediation by the operating system 104. Thus, the NV heap 204 is shared with the application 108. In previous systems, applications were provided read/write access to the NV heap 204 such that the applications could update portion(s) of the NV heap 204. In contrast, in the illustrated example, the sharing access of the application with the NV heap 204 is limited to read-only access. In particular, the run-time system 202 only loads type-safe applications that treat the NV heap 204 as immutable. That is, due to the type-safety aspect of the languages allowed by the run-time system 202 (e.g., Erlang), the application is limited to read-only access with respect to the NV heap 204. Thus, only a read call 206 from the application 108 is allowed to be directly shared with the NV heap 204. By allowing only the read call 206 from the application 108 (e.g., and not write calls), the NV heap manager 114 restricts (e.g., via the run-time system 202) the exposure of the NV heap 204 to potential bugs and/or writing of malicious code due to crash(es) of the application 108. Thus, the example NV heap manager 114 manages interactions between the application 108 and the NV heap 204 with the application 108 restricted to read-only access at the application language level.

The example NV heap manager 114 of FIG. 2 includes a handle 208 to facilitate access to the NV heap 204. The handle 208 of the NV heap manager 114 provides a current reference point or offset into the NV heap 204 that can be used to find a location of the NV heap 204. In some examples, additional handles are implemented in connection with the NV heap 204. As described in greater detail below, the NV heap manager 114 refreshes the handle 208 to reflect changes or updates to the NV heap 204. In the illustrated example of FIG. 2, the handle 208 is shown having a value V that corresponding to a current version pointer of the NV heap 204. The current version pointer of the NV heap 204 refers to a reference point in the NV heap 204 from which an offset can be used to find a location of the NVRAM 112. As shown in FIG. 2, when the application 108 issues a read call, the run-time system 202 directs a corresponding read call 206 to the handle 208, which provides the reference point V that the read request 206 can use to locate the desired portion of the NVRAM 112.

The NV heap manager 114 of the illustrated example provides a trusted module 210 to update (e.g., write to) the NV heap 204 in accordance with a write call from the application 108. The example trusted module 210 cooperates with the run-time system 202 to direct the write call (e.g., a native function call to write to the NVRAM 112) from the application 108 to the trusted module 210 as an update request 212. The run-time system 202 of the illustrated example compiles write calls from the application 108 such that the update request 212 including information associated with the write call is directed to the trusted module 210. As described above, the application 108 has read-only access to the NV heap 204. In other words, the application 108 is forbidden (e.g., at the application language level) from writing to the NV heap 204.

Instead of allowing the application 108 to perform a write to the NV heap 204 as in previous systems, the example NV heap manager 114 of FIG. 2 provides the trusted module 210 and charges the trusted module 210 with performing writes to the NV heap 204 generated by the application 108. In comparison with the application 108, which can originate at any source, the trusted module 210 is generated by trusted source(s) (e.g., the designers of the computing platform 100) and is tightly controlled and simple. That is, the trusted module 210 of the illustrated example does not include variable, unknown code that may corrupt the NV heap 204 upon a crash of the application 108. Instead, the trusted module 210 includes limited code (e.g., less than fifty lines) dedicated to a direct update of the NV heap 204. Accordingly, the trusted module 210 is far less likely (if at all) to corrupt data of the NV heap 204 than the application 108, which includes complex code in which bugs or malicious code may occur and is not dedicated solely to the NV heap manager 114. In some examples, the trusted module 210 is written in a type-unsafe language, such as ‘C.’ In contrast, the applications 108 with which the NV heap 204 interacts are written in a type-safe, functional language, such as Erlang.

To update a persistent data structure (PDS) 216 employed by the example NV heap manager 114, the example trusted module 210 of FIG. 2 includes a PDS versioner 218. The example PDS 216 of FIG. 2 is configured by the NV heap manager 114 to span across the entire NV heap 204. Therefore, the content of the PDS 216 corresponds to the content of the NV heap 204. The PDS 216 is a backup mechanism. The PDS 216 preserves a previous version of itself each time the corresponding data structure (the NV heap 204 in FIG. 2) is modified. The PDS 216 stores each version of itself so that the NV heap 204 can be returned to a previous state by reinstating one of the previous PDS versions. In response to the update request 212 and the resulting write operation performed by the memory updater 214, the PDS versioner 218 facilitates creation of a new version of the PDS 216. For example, as shown in FIG. 2, the update request 212 results in a new configuration of the NV heap 204 in which the current version pointer refers to V′ instead of V. Thus, the PDS versioner 218 of the illustrated example stores the version of the PDS 216 in which the current version pointer refers to V, and creates a new version of the PDS 216 in which the pointer of the NV heap 204 refers to V′. Thus, the PDS 216 provides the NV heap manager 114 with one or more backup versions of the NV heap 204 that can be loaded into the NVRAM 112 in the event of a corruption.

The example PDS versioner 218 of FIG. 2 includes a memory updater 214 to perform direct write operations on the NV heap 204. As described above, the memory updater 214 of the illustrated example includes tightly controlled, simple code dedicated to performing updates of the NV heap 204. When a write call is issued by the application 108 and the run-time system 202 directs the corresponding update request 212 to the trusted module 210, the memory updater 214 of the illustrated example performs the appropriate write to the NV heap 204 in accordance with the details of the update request 212. To perform the update, the example memory updater 214 references the handle 208 to obtain a reference point (e.g., V) to the current version pointer of the NV heap 204. Additionally, when the write operation performed by the memory updater 214 alters the current version pointer of the NV heap 204, the handle 208 is refreshed such that the handle 208 reflects the new position referenced by the current version pointer of the NV heap 204. The handle 208 can be refreshed by the example NV heap manager 114 or by the application 108 (e.g., as part of the write call). Additionally, the example NV heap manager 114 of FIG. 2 checks that the handle 208 is up to date or current (e.g., that the current reference is accurate) to maintain a consistent sequence of updates. In the illustrated example of FIG. 2, the update request 212 results in the memory updater 214 performing a write operation and the current version pointer being altered to a new position, labeled as V′ in FIG. 2. After such an operation, the memory updater 214 refreshes the handle 208 to refer to V′ as the reference point.

While an example manner of implementing the NV data structure manager 114 of FIG. 1 has been illustrated in FIG. 2, one or more of the elements, processes and/or devices illustrated in FIG. 2 may be combined, divided, re-arranged, omitted, eliminated and/or implemented in any other way. Further, the example handle 208, the example trusted module 210, the example memory updater 214, the example PDS versioner 218, the example PDS 216, and/or, more generally, the example NV heap manager 114 of FIG. 2 may be implemented by hardware, software, firmware and/or any combination of hardware, software and/or firmware. Thus, for example, any of the example handle 208, the example trusted module 210, the example memory updater 214, the example PDS versioner 218, the example PDS 216, and/or, more generally, the example NV heap manager 114 of FIG. 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example handle 208, the example trusted module 210, the example memory updater 214, the example PDS versioner 218, the example PDS 216, and/or, more generally, the example NV heap manager 114 of FIG. 2 are hereby expressly defined to include a tangible and/or non-transitory computer readable medium such as a physical memory, DVD, CD, etc. storing the software and/or firmware. Further still, the example NV heap manager 114 of FIG. 2 may include one or more elements, processes and/or devices in addition to, or instead of, those illustrated in FIG. 2, and/or may include more than one of any or all of the illustrated elements, processes and devices.

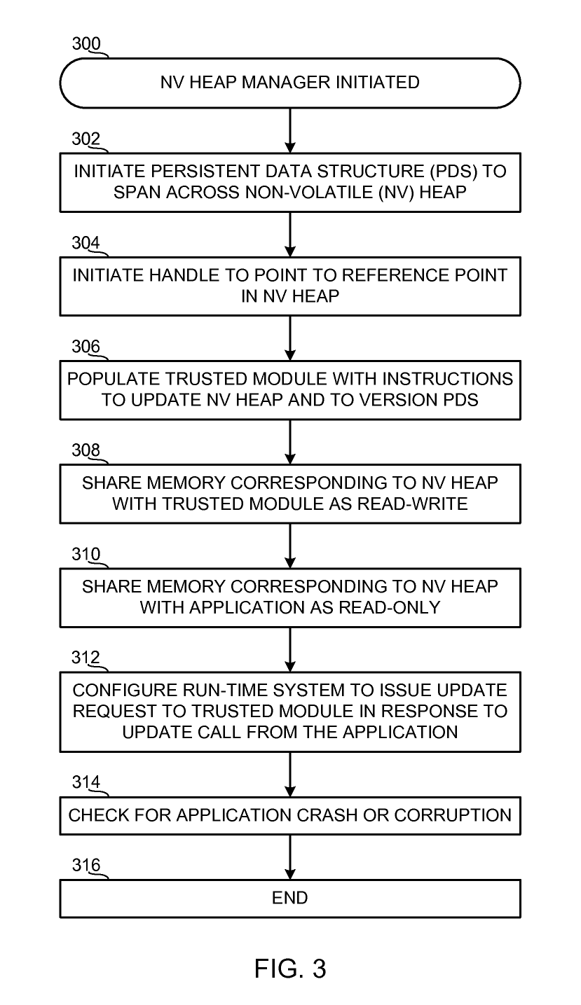

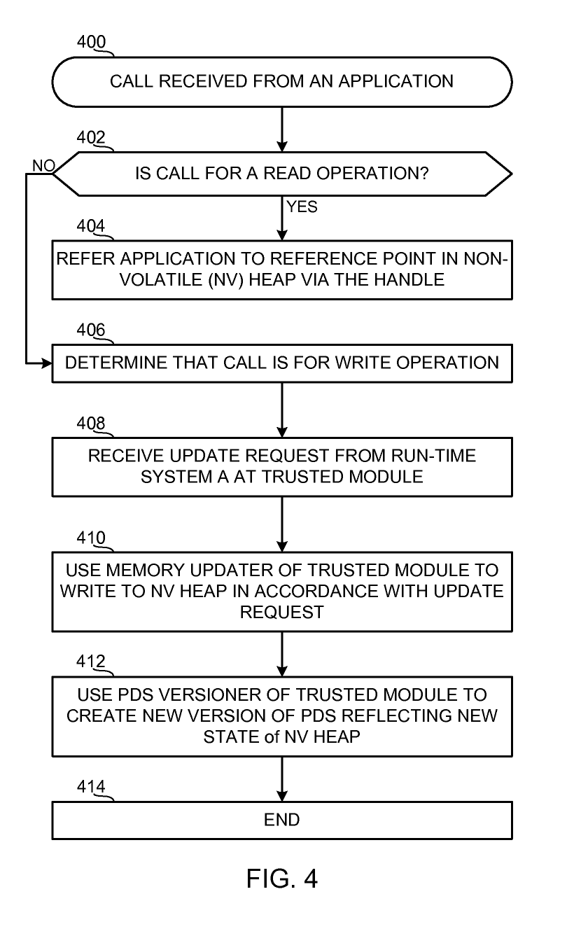

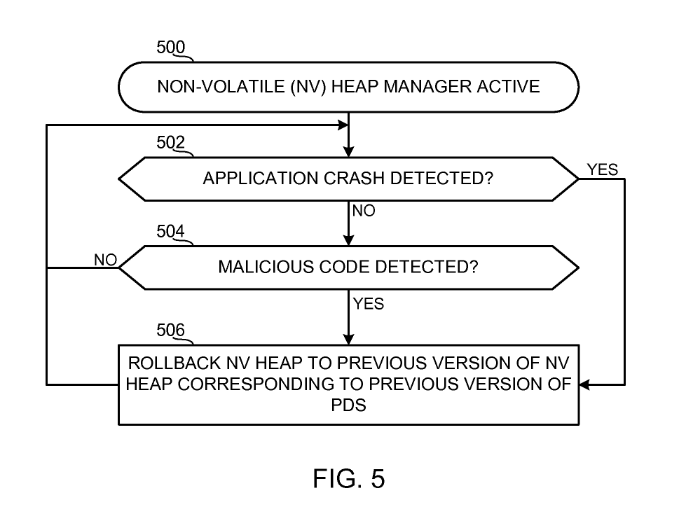

FIG. 3 is a flowchart representative of example machine readable instructions which may be executed to initialize the example NV heap manager 114 of FIG. 2. FIG. 3 is described in detail below. FIG. 4 is a flowchart representative of example machine readable instructions which may be executed to operate the example NV heap manager 114 of FIG. 2. FIG. 4 is described in detail below. FIG. 5 is a flowchart representative of example machine readable instructions which may be executed to restore the example NV heap 204 using the NV heap manager 114 of FIG. 2. FIG. 5 is described in detail below. In the examples of FIGS. 3-5, the machine readable instructions comprise programs and/or routines for execution by a processor such as the processor 102 shown in the example computing platform 100 discussed above in connection with FIG. 1. The programs may be embodied in software stored on a computer readable medium such as a CD-ROM, a floppy disk, a hard drive, a digital versatile disk (DVD), and/or any form of physical memory associated with the processor 102, but the entire program and/or parts thereof could alternatively be executed by a device other than the processor 102 and/or embodied in firmware or dedicated hardware. Further, although the example programs are described with reference to the flowcharts illustrated in FIGS. 3-5, many other methods of implementing the example NV heap manager 114 may alternatively be used. For example, the order of execution of the blocks may be changed, and/or some of the blocks described may be changed, eliminated, or combined.

As mentioned above, the example processes of FIGS. 3-5 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 3-5 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

The example of FIG. 3 begins as the NV heap manager 114 is initiated or activated (block 300). The NV heap manager 114 initiates or establishes the PDS 216 as spanning across (e.g., covering the entirety of) the NV heap 204 to be managed by the NV heap manager 114 (block 302). Because the PDS 216 spans across the NV heap 204, the content of each version of the PDS 216 corresponds to the content of the NV heap 204. The NV heap manager 114 also initiates the handle 208 to pointer to a reference point in the NV heap 204 (block 304). In the illustrated example, the handle 208 is initiated and refreshed to refer to the current pointer version of the NV heap 204. The trusted module 210 is populated with the instructions or code needed to perform a write operation in the NV heap 204 and to version the PDS 216 (block 306). The example NV heap manager 114 configures the run-time system 202 to enforce sharing restrictions related to the NV heap 204. In particular, the NV heap manager 114 grants the trusted module 210 read/write access to the NV heap 204 (block 308). The NV heap manager 114 limits applications (e.g., the application 108) to read-only access to the NV heap 204 by configuring the run-time system 202 to refuse to load applications that do not view the NV heap as immutable (block 310). Additionally, the NV heap manager 114 configures the run-time system 202 to issue an update request 212 to the trusted module 210 in response to a write call from the application 108 (block 312). For example, the NV heap manager 114 may cause compilation associated with the run-time system 202 to result in a write call from the application 108 as being compiled into the update request 212 that is routed to the trusted module 210. The NV heap manager 114 then checks for application crashes, corruptions, and/or other problematic conditions as part of the initialization of FIG. 3 (block 314). Example checks for such conditions are described in detail below in connection with FIG. 5. The example of FIG. 3 then ends (block 316).

FIG. 4 begins with a call received from the application 108 (block 400). If the call is a read call (block 402), the handle 208 refers the application 108 to a reference point in the NV heap and the application 108 is able to read the appropriate location in memory (block 404). As described above, the NV heap manager 114 shares the NV heap with the application 108 as read-only. Therefore, the application 108 is allowed to read from the NV heap 204. This does not expose the NV heap 204 to potential data corruption because the application 108 is only granted read access (e.g., not write access). The application 108 is type-safe (e.g., coded in a language such as Erlang) and, thus, the application 108 inherently views the NV heap 204 as immutable.

Referring back to block 402, when the received call is not for a read operation, the NV heap manager 114 determines that the received call is for a write operation (block 406). Because the run-time system 202 is configured to route write operations from the application 108 to the trusted module 210 as the update request 212 (block 312 of FIG. 3), the trusted module 210 receives the update request 212 (block 408). In contrast to the application 108, the trusted module 210 has read/write access to the NV heap 204 and, thus, is able to perform a write operation on the NV heap 204 in accordance with the update request 212. In particular, the memory updater 214 of the trusted module 210 uses the reference point of the handle 208 and the details of the update request 212 to perform a write operation on the NV heap 204 (block 410). In the illustrated example, after the write operation, the handle 208 is refreshed to accurately reflect the current version pointer of the NV heap 204. In some examples, more than one write operation may be performed before the handle 208 is updated. In some examples, more than one handle may be refreshed at a different time than another handle. In some examples, the change(s) made to the handle 208 can be visible to other components (or sub-components) at a later time than the refresh itself. Additionally, the PDS versioner 218 of the trusted module 210 creates a new version of the PDS 216 to reflect the new state of the NV heap 204 (block 412). As described above, the PDS 216 is a backup mechanism of which a new version is created each time the NV heap 204 is modified. Thus, the memory updater 214 update the NV heap 204 by versioning the PDS 216. The example of FIG. 4 then ends (block 414).

The example of FIG. 5 begins with the NV heap manager 114 managing the NV heap 204 (block 500). Alternatively, the example of FIG. 5 may be performed as part of the initialization of the NV heap manager 114 described above in connection with FIG. 3. As described above, the PDS 216 enables the NV heap manager 114 to rollback the NV heap 204 to a previous version by maintaining a new version of the PDS 216, which spans the NV heap 204 and mirrors the content of the NV heap 204, each time the NV heap 204 is modified. In the example of FIG. 5, the NV heap manager 114 determines whether the application 108 (or any other application associated with the NV heap 204) has crashed (block 502). If not, the NV heap manager 114 determines whether data of the NV heap 204 has been corrupted due to, for example, malicious code and/or a crash (block 504). If the NV heap manager 114 determines that either the application 108 has crashed at block 502 or that data in the NV heap 204 has been corrupted at block 504, the NV heap manager 114 utilizes the PDS 216 to rollback the NV heap to a previous version (block 506). The previous version stored by the PDS 216 corresponds to an uncorrupted state of the NV heap 204 and, thus, restores the NV heap 204 to an uncorrupted state.

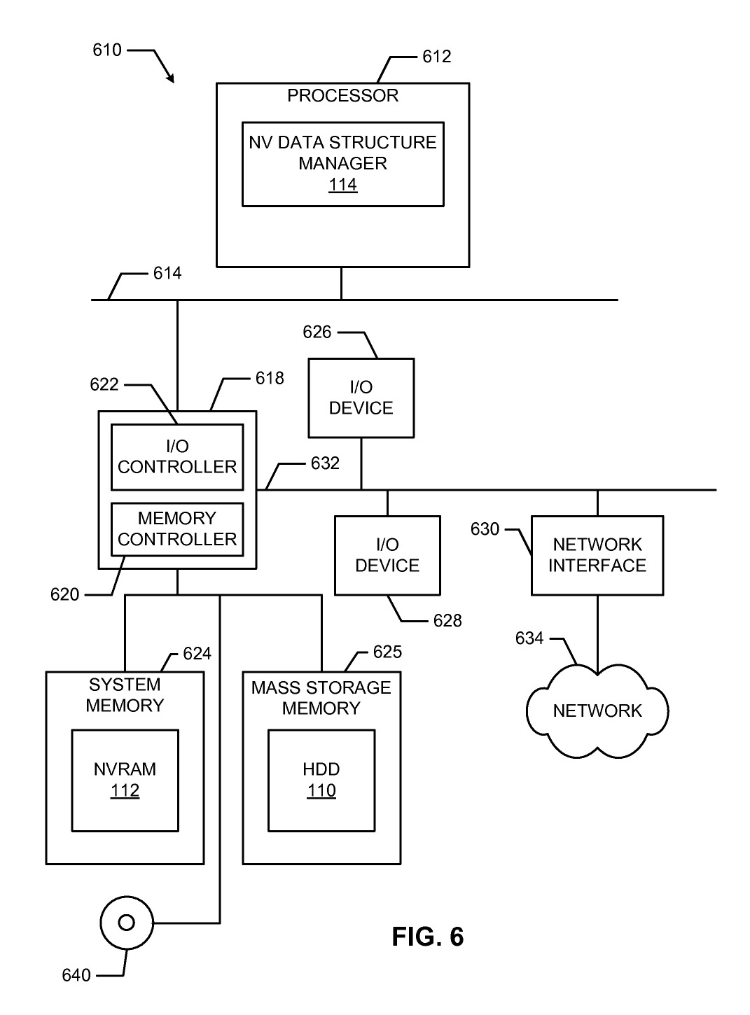

FIG. 6 is a block diagram of an example processor system 610 that may be used to execute the machine readable instructions of FIGS. 3-5 to implement the example NV heap manager 114 of FIG. 2. The example processor system 610 of FIG. 6 includes a processor 612 that is coupled to an interconnection bus 814. The example processor 612 of FIG. 6 may correspond to the example processor 102 of FIG. 1. The processor 612 may be any suitable processor, processing unit, or microprocessor (e.g., one or more Intel® microprocessors from the Pentium® family, the Itanium® family or the XScale® family and/or other processors from other families). The system 610 may be a multi-processor system and, thus, may include one or more additional processors that are identical or similar to the processor 612 and that are communicatively coupled to the interconnection bus 614. In the illustrated example of FIG. 6, the processor 612 implements the NV data structure manager heap manager 114 of FIG. 1, an example implementation of which is shown and described in connection with FIG. 2 above.

The processor 612 of FIG. 6 is coupled to a chipset 618, which includes a memory controller 620 and an input/output (I/O) controller 622. A chipset provides I/O and memory management functions as well as a plurality of general purpose and/or special purpose registers, timers, etc. that are accessible or used by one or more processors coupled to the chipset 618. The memory controller 620 performs functions that enable the processor 612 to access a system memory 624, a mass storage memory 625, and/or a digital versatile disk (DVD) 640. With reference to FIG. 1, the memory controller 620 may perform memory operations for certain types of memory, such as the HDD 110 of FIG. 1, shown as implemented in the mass storage memory 625 in FIG. 6. For other types of memory, such as the NVRAM 112, which is shown in FIG. 6 as implemented in the system memory 624, the NV data structure manager 114 may perform memory operations without intervention or mediation by an operating system, unlike the memory controller 620.

In general, the system memory 624 may include any desired type of volatile and/or non-volatile memory such as, for example, static random access memory (SRAM), dynamic random access memory (DRAM), flash memory, read-only memory (ROM), etc. The mass storage memory 825 may include any desired type of mass storage device including hard disk drives, optical drives, tape storage devices, etc. The machine readable instructions of FIGS. 3-5 may be stored in the system memory 624, the mass storage memory 625, and/or the DVD 640.

The I/O controller 622 performs functions that enable the processor 612 to communicate with peripheral input/output (I/O) devices 626 and 628 and a network interface 630 via an I/O bus 632. The I/O devices 626 and 628 may be any desired type of I/O device such as, for example, a keyboard, a video display or monitor, a mouse, etc. The network interface 630 may be, for example, an Ethernet device, an asynchronous transfer mode (ATM) device, an 802.11 device, a digital subscriber line (DSL) modem, a cable modem, a cellular modem, etc. that enables the processor system 610 to communicate with another processor system. The example network interface 630 of FIG. 6 is also communicatively coupled to a network 634, such as an intranet, a Local Area Network, a Wide Area Network, the Internet, etc.

While the memory controller 620 and the I/O controller 622 are depicted in FIG. 6 as separate functional blocks within the chipset 618, the functions performed by these blocks may be integrated within a single semiconductor circuit or may be implemented using two or more separate integrated circuits.

Although certain example apparatus, system, methods, and articles of manufacture have been disclosed herein, the scope of coverage of this patent is not limited thereto. On the contrary, this patent covers all apparatus, system, methods, and articles of manufacture fairly falling within the scope of the claims of this patent.

What is claimed is:

1. A non-volatile data structure manager, comprising:
a persistent data structure (PDS) to maintain at least one version of a non-volatile heap;
a PDS versioner to create a version of the PDS reflective of a state of the non-volatile heap; and
a memory updater to perform a direct memory update of the non-volatile heap in response to a write call routed from an application that shares a region of memory corresponding to the non-volatile heap as read-only, wherein the creation of the version of the PDS is caused by the direct memory update.

2. A non-volatile heap manager as defined in claim 1, wherein performing the direct memory update of the non-volatile heap comprises altering data of the non-volatile heap without mediation by an operating system.

3. A non-volatile heap manager as defined in claim 1, wherein an update request associated with the call from the application is to be routed to the memory updater by a run-time system.

4. A non-volatile heap manager as defined in claim 1, wherein the region of memory is shared with the memory updater as read/write.

5. A non-volatile heap manager as defined in claim 1, further comprising a handle representative of a current pointer of the non-volatile heap.

6. A non-volatile heap manager as defined in claim 7, wherein the memory updater is to refresh the handle after performing the direct memory update.

7. A non-volatile heap manager ad defined in claim 1, wherein the PDS includes a previous version of the non-volatile heap, and the non-volatile heap is to be rolled back to a uncorrupted state using the previous version in the PDS in the event of a crash of the application.

8. A method of managing a non-volatile data structure, comprising:
directing an update request associated with a write call received from an application to a trusted module designated to update a non-volatile heap, the application being limited to read-only access to the non-volatile heap;
performing, using the trusted module, a direct memory update of the non-volatile heap in response to the update request;
maintaining a persistent data structure (PDS) spanning the non-volatile heap to include a version of the non-volatile heap; and
creating a current version of the PDS in response to the direct memory update modifying the non-volatile heap.

9. A method as defined in claim 8, wherein performing the direct memory update of the non-volatile heap comprises altering data of the non-volatile heap without mediation by an operating system.

10. A method as defined in claim 8, wherein redirecting the update request associated with the write call to the trusted module is performed by a run-time system.

11. A method as defined in claim 8, wherein the non-volatile heap corresponds to a region of non-volatile random access memory (NVRAM) that is shared by the application as read-only and shared by the memory updater as read/write.

12. A method as defined in claim 8, further comprising maintaining a handle representative of a current pointer of the non-volatile heap.

13. A method as defined in claim 12, further comprising refreshing the handle after performing the direct memory update.

14. A method as defined in claim 8, wherein the PDS includes a previous version of the non-volatile heap, and further comprising rolling back the non-volatile heap to an uncorrupted state using the previous version in the PDS in the event of a crash of the application.

15. A tangible machine readable medium having instructions stored thereon that, when executed, cause a machine to at least:
redirect an update request associated with a write call received from an application to a trusted module designated to update a non-volatile heap, the application having read-only access to the non-volatile heap;
perform, using the trusted module, a direct memory update of the non-volatile heap in response to the update request;
maintain a persistent data structure (PDS) to include at least one version of the non-volatile heap; and
create a current version of the PDS in response to the direct memory update modifying the non-volatile heap.

16. A machine readable medium as defined in claim 15, wherein the instructions are to cause the machine to perform the direct memory update of the non-volatile heap by altering data of the non-volatile heap without mediation by an operating system.

17. A machine readable medium as defined in claim 15, wherein the instructions are to cause the machine to redirect the update request associated with the write call to the trusted module via a run-time system.

18. A machine readable medium as defined in claim 15, wherein the non-volatile heap corresponds to a region of non-volatile random access memory (NVRAM) that is shared by the application as read-only and shared by the memory updater as read/write.

19. A machine readable medium as defined in claim 15, wherein the instructions are to cause the machine to maintain a handle representative of a current pointer of the non-volatile heap.

20. A method as defined in claim 8, wherein the PDS includes a previous version of the non-volatile heap, and wherein the instructions cause the machine to roll back the non-volatile heap to a uncorrupted state using the previous version in the PDS in the event of a crash of the application.
